(19) United States
(12) Patent Application Publication
(10) Pub. No.: US 2005/0028885 A1
(43) Pub. Date: Feb. 10, 2005

(54) Discharge preventer for a line produced using the gas-assisted injection molding process

(76) Inventor: Thomas Zapp, Dortmund (DE)

Correspondence Address: Richard A. Speer;MAYER, BROWN, ROWE & MAW LLP, P.O. Box 2828, Chicago, IL, 60690-2828, US

(21) Appl. No.: 10/874,610

(22) Filed: Jun. 22, 2004

(30) Foreign Application Priority Data
Jun. 23, 2003 (DE) 103 28 266.1

(51) Int. Cl. B65B 31/00; H01R 4/24

(52) U.S. Cl. 141/59

(57) ABSTRACT

In a device for connecting a line (1), produced using the gas-assisted injection molding process, of a fuel tank to a further component, a connection piece (2) is joined cohesively to the line (1). The connection piece (2) includes a nonreturn valve (3) which can be moved into an open position by a tube piece (8′) arranged at the component. This allows the device to be manufactured at particularly low cost.

### BACKGROUND OF THE INVENTION

The invention relates to a discharge preventer for a line, produced using the gas-assisted injection molding process, of a fuel tank.

A discharge preventer of this type is in widespread use in modern motor vehicles, for example in fuel filters or at ventilation devices, and is known from practical applications. The lines produced using the gas-assisted injection molding process are generally produced integrally with a component of the fuel filter or the ventilation device. The gas-assisted injection molding process allows the line to be produced at particularly low cost. The components to be connected to these lines are generally lines or devices, for example. In the case of the device which is known in practice, the free end of the line produced using the gas-assisted injection molding process is subsequently shaped to form a flange. The further component is connected to this flange.

A drawback of the known device is that the complex shaping of the free end of the line produced using the gas-assisted injection molding process leads to a considerable increase in the manufacturing costs.

The invention is based on the problem of configuring a device of the type described in the introduction in such a way that it can be produced at particularly low cost.

### BRIEF DESCRIPTION OF THE INVENTION

According to the invention, this problem is solved by a connection piece which can be connected to the further component being inserted into the open end of the line and being sealed with respect to the line.

This configuration allows the connection piece to be matched to the component to be connected to it. Therefore, the line produced using the gas-assisted injection molding process can in the simplest case be produced without re-machining in a simple cylindrical shape. This leads to particularly low manufacturing costs for the device according to the invention.

According to an advantageous refinement of the invention, the connection piece can simply be press-fitted into the lines produced using the gas-assisted injection molding process, if it is substantially cylindrical in form on its outer side. To increase the stability of the join, the connection piece may have encircling flutes or a fir-tree profile on its outer side.

The connection piece could, for example, be clipped to the line. However, according to another advantageous refinement of the invention, the connection piece can be secured in a particularly simple way and, at the same time, sealed with respect to the line if the connection piece is joined cohesively to the line.

The cohesive nature of the join between the connection piece and the line could, for example, be produced using adhesive. However, the costs of the device according to the invention are further reduced if the connection piece is welded to the line.

The line produced using the gas-assisted injection molding process must additionally be protected using a nonreturn valve. According to another advantageous refinement of the invention, it is possible to avoid the need to fit additional components if the connection piece includes a nonreturn valve.

According to another advantageous refinement of the invention, it is possible to prevent the line produced by gas-assisted injection molding from running empty during maintenance work when it is fitted in the fuel tank if a valve body of the nonreturn valve, when the further component is being connected to the connection piece, can be moved from a position in which it closes the nonreturn valve into a position in which it opens the nonreturn valve.

According to another advantageous refinement of the invention, the nonreturn valve is of particularly simple design if the further component has a tube piece with a rod which is arranged thereon and is designed to move the valve body.

According to another advantageous refinement of the invention, the design of the nonreturn valve is further simplified if the further component has a recess arranged in the vicinity of the free end of the tube piece and is designed to move the valve body by means of the tube piece.

According to another advantageous refinement of the invention, fuel can be reliably prevented from being discharged from the nonreturn valve while the component connected to the line is being disconnected if the non-return valve is closed when the component has been almost completely disconnected from the connection stub.

### BRIEF DESCRIPTION OF THE DRAWINGS

The invention permits numerous embodiments. To further illustrate its basic principle two of these are illustrated in the drawing and described below. In the drawing:

FIG. 1 shows a device according to the invention in longitudinal section before a further component is attached,

FIG. 2 shows the device according to the invention from FIG. 1 after the further component has been attached,

FIG. 3 shows a further embodiment of the device according to the invention.

### DETAILED DESCRIPTION OF THE INVENTION

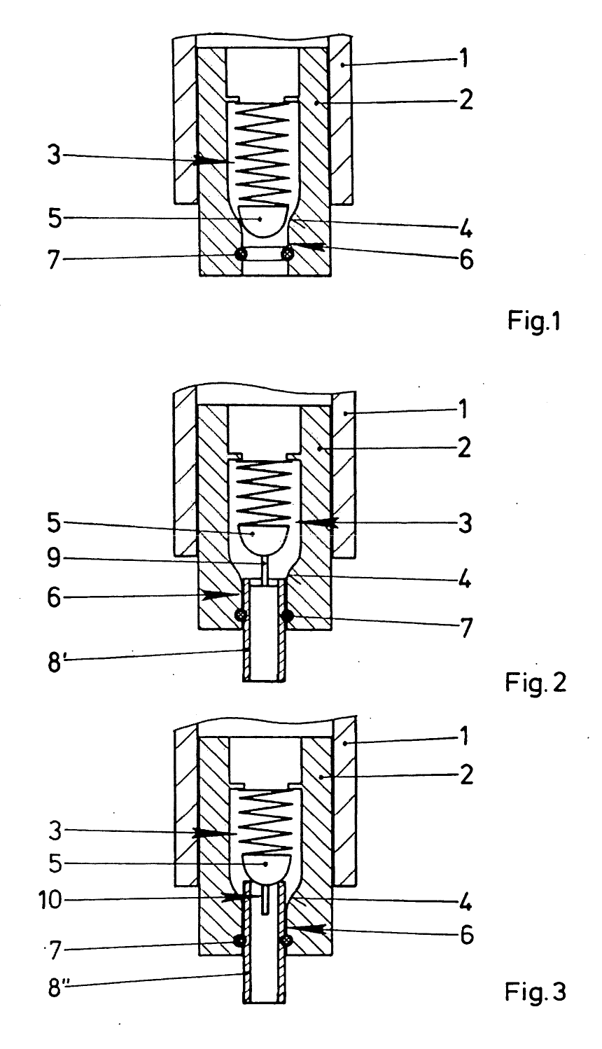

FIG. 1 shows a device which is to be used in a fuel tank of a motor vehicle and has a line 1, which is produced using the gas-assisted injection molding process, and a connection piece 2 which is secured in the line 1 and sealed with respect to the latter. When the line 1 is being produced using the gas-assisted injection molding process, liquid plastic is introduced into a mold and the mold is cooled. In the process, the plastic solidifies at the wall of the mold. Then, the liquid plastic is blown out, so that the plastic which has solidified at the wall of the mold forms the line 1 produced using the gas-assisted injection molding process. The connection piece 2 may be joined to the line 1, by way of example, by means of the friction-welding process. The connection piece 2 has a nonreturn valve 3. The nonreturn valve 3 has a valve body 5, which is preloaded with respect to a valve seat 4 in the position illustrated, and is therefore in the closed position. A cylindrical recess 6 with an O-ring 7 is arranged at the end which projects out of the line 1. The recess 6 serves to receive a tube piece 8 illustrated in FIG. 2.

FIG. 2 shows the device from FIG. 1 with the tube piece 8′ of a further component (not shown) introduced into the recess 6 in the connection piece 2. The further component may, for example, be a further line (not shown) or a fuel filter. At its free end, the tube piece 8′ has a rod 9 which, in the position illustrated, presses the valve body 5 away from the valve seat 4. As a result, the nonreturn valve 3 is in the open position. The O-ring 7 seals the tube piece 8′ with respect to the recess 6.

FIG. 3 shows a further embodiment of the device according to the invention, in which a tube piece 8″ has a lateral recess 10 in the vicinity of its free end. In the position illustrated, the end side of the tube piece 8″ presses the valve body 5 away from the valve seat 4. Therefore, fuel or air can flow from the line 1 produced by gas-assisted injection molding through the nonreturn valve 3 and the recess 10 in the tube piece 8″ to the component connected to the tube piece 8″.

The dimensions of the tube pieces 8′, 8″ from FIGS. 2 and 3 and the recess 6 in the connection piece 2 are such that the valve body 5 reaches the valve seat 4 when the tube piece 8′, 8″ has been almost completely pulled out of the recess 6.

1. A discharge preventer for connection of a line, produced using the gas-assisted injection molding process, of a fuel tank, characterized in that a connection piece (2) which can be connected to a further component is inserted into the open end of the line (1) and is sealed with respect to the line (1).

2. The discharge preventer as claimed in claim 1, characterized in that the connection piece (2) is substantially cylindrical in form, on its outer side.

3. The discharge preventer as claimed in claim 1 or 2, characterized in that the connection piece (2) is joined cohesively to the line (1).

4. The discharge preventer as defined in claim 1, characterized in that the connection piece (2) is welded to the line (1).

5. The discharge preventer as defined in claim 1 or 4, characterized in that the connection piece (2) includes a nonreturn valve (3).

6. The discharge preventer as defined in claim 5, characterized in that a valve body (5) of the nonreturn valve (3), when the further component is being connected to the connection piece (2), can be moved from a position in which it closes the nonreturn valve (3) into a position in which it opens the nonreturn valve (3).

7. The discharge preventer as defined in claim 1, characterized in that the further component has a tube piece (8′) with a rod (9) which is arranged thereon and is designed to move the valve body (5).

8. The discharge preventer as defined in claim 1, characterized in that the further component has a recess (10) arranged in the vicinity of the free end of the tube piece (8″) and is designed to move the valve body (5) by means of the tube piece (8″).

9. The discharge preventer as defined in claim 5, characterized in that the nonreturn valve (3) is closed when the component is almost completely disconnected from the connection stub (2).
